(19) United States
(12) Patent Application Publication
(10) Pub. No.: US 2025/0379834 A1
(43) Pub. Date: Dec. 11, 2025

(54) METHOD, SERVER, AND USER TERMINAL FOR DISPLAYING COMMAND GUIDE INFORMATION FOR CHATBOT

(71) Applicant: KAKAO CORP., Jeju-si (KR)

(72) Inventors: Dong Hyun BAN, Seongnam-si (KR); Soo Bum KIM, Seongnam-si (KR); Jae Young JANG, Seongnam-si (KR); Bo Mi HONG, Seongnam-si (KR); Jeong Um LEE, Seoul (KR); Ho Geun KWAK, Seongnam-si (KR); Jeong Hyeon LEE, Seongnam-si (KR); Jun Yong AHN, Seongnam-si (KR); Ji Soo HWANG, Seongnam-si (KR); Mu Tae YANG, Seongnam-si (KR); Hyeok Jin KWON, Seongnam-si (KR); Min Jeong KANG, Seongnam-si (KR); Gi Pyo KIM, Seongnam-si (KR); Ka Young SONG, Seongnam-si (KR); Seung Uk JEONG, Seongnam-si (KR); Sung Yong CHANG, Seongnam-si (KR); Jeong Ryeol CHOI, Seongnam-si (KR); Jeong Ho JO, Seongnam-si (KR); Yu Jin HUH, Seongnam-si (KR); Ye Ram HAN, Seongnam-si (KR); Gi Woo KANG, Seongnam-si (KR); Su Woong BYUN, Seongnam-si (KR); Young Eun KIM, Seongnam-si (KR); Tae In KIM, Seoul (KR); Hyeong Woo KIM, Seongnam-si (KR); Bo Kyung KIM, Seongnam-si (KR); Kyeong Un CHOI, Seongnam-si (KR); Hyeon Mo JEONG, Seongnam-si (KR); Chang Hwa JOA, Seongnam-si (KR); O Seok HAN, Seoul (KR); No Suk MYUNG, Seongnam-si (KR); Yun Ho CHOI, Seongnam-si (KR); Minna YOUN, Seongnam-si (KR)

(21) Appl. No.: 19/214,557

(22) Filed: May 21, 2025

(30) Foreign Application Priority Data
Jun. 10, 2024 (KR) 10-2024-0075321

(51) Int. Cl. H04L 51/02; H04L 51/04

(52) U.S. Cl. CPC H04L 51/02; H04L 51/04

(57) ABSTRACT

Proposed is a method for displaying command guide information for a chatbot by a user terminal. The method may include acquiring an input for specifying a chatbot through a chat room, the chatbot providing a chatbot response message corresponding to the command through the chat room. The method may also include displaying command guide information for the chatbot in the chat room, and acquiring input information for a command based on the command guide information. The method may further include displaying a command message comprising the command corresponding to the input information in the chat room, and displaying a chatbot response message corresponding to the command message in the chat room.

### CROSS-REFERENCE TO RELATED APPLICATION

This application claims priority to and the benefit of Korean Patent Application No. 10-2024-0075321 filed on Jun. 10, 2024, the disclosure of which is incorporated herein by reference in its entirety.

### BACKGROUND

### Technical Field

The present disclosure relates to a method for a user terminal to display command guide information for a chatbot through a chat room.

### Description of Related Technology

Recent chatbots may interact with users through conversational interfaces. These chatbots may be used primarily in chat services or on specific platforms. Users may converse with chatbots by inputting text-based messages, and a chatbot generates response messages corresponding to user questions using pre-determined information and algorithms to answer users' questions or provide services.

### SUMMARY

One aspect is to specify one chatbot among a plurality of chatbots through a chat room and to provide guide information on commands included in the specified chatbot to the user, thereby allowing the user to use the chatbot more conveniently.

Another aspect is to provide command guide information to the user based on the specification of a chatbot, and to provide a chatbot response message corresponding to a command in the chat room when the user inputs a command message.

Another aspect is a method for displaying command guide information for a chatbot by a user terminal, that includes: acquiring an input for specifying a chatbot through a chat room, the chatbot providing a chatbot response message corresponding to the command through the chat room; displaying command guide information for the chatbot in the chat room; acquiring input information for a command based on the command guide information; displaying a command message comprising the command corresponding to the input information in the chat room; and displaying a chatbot response message corresponding to the command message in the chat room.

The displaying of the command guide information may include; displaying at least one primary command option; acquiring selection information for at least one primary command option from a user; and displaying at least one secondary command option determined based on the selection information.

The displaying of the command guide information may include displaying at least one command option. A manner in which the at least one command option is displayed may be determined based on at least one of a chat history of the chat room and a command usage history of the user.

The method may further include displaying the command corresponding to the input information in a message input field of the chat room. The displaying of the command may be performed between the acquiring of the input information and the displaying of the command message.

The method may further include displaying information for specifying the chatbot in the message input field. The displaying of the information for specifying the chatbot may be performed between the acquiring of an input for specifying the chatbot and the acquiring of the input information. In the displaying of the command, the command may be displayed in the message input field together with the information for specifying the chatbot.

The displaying of the command message may include: acquiring a user's interaction for sending the command message displayed in the message input field; and displaying the command message in a message display window of the chat room.

The method may further include acquiring input information for a command through a typing interaction on a message input field of the chat room. The acquiring of the input information for the command may be performed instead of the acquiring of the input information based on the command guide information.

The method may further include stopping the displaying of the command guide information when input information for a command is acquired through a method other than using the command guide information. The stopping of the displaying of the command may be performed after the displaying of the command guide information is performed.

The displaying of the chatbot response message may further include displaying command guide information for the chatbot at a location corresponding to the chatbot response message in the message display window of the chat room.

The command guide information displayed in the message display window may include command options for commands other than the command corresponding to the input information.

The acquiring of the input for specifying the chatbot may include: displaying list information about participating chatbots that are participating in the chat room; and acquiring an input for specifying the chatbot through the list information for specifying a chatbot. A manner in which the list information may be displayed is determined based on at least one of a chat history of the chat room and a command usage history of the user.

The list information may include command guide information for one of the participating chatbots. The command guide information for the chatbot may be displayed as a replacement for command guide information for one of the participating chatbots.

In the acquiring of the input for specifying the chatbot, the input for specifying the chatbot may include an input for utterance information of the chatbot in the chat room.

The Input for the utterance information of the chatbot may include at least one of an input for replying to a spoken message from the chatbot and an input for speaker information of the chatbot.

The command guide information may include an interface for requesting a chatbot response message corresponding to a command and an interface related to settings of the chatbot.

The interface related to the settings of the chatbot may include at least one of an interface for resetting configuration settings of the chatbot and an interface for allowing a proactive message that is not a response to a command message.

Another aspect is a user terminal displaying command guide information for a chatbot, that includes a memory storing instructions and a processor configured to execute the instructions to: acquire an input for specifying a chatbot through a chat room, the chatbot providing a chatbot response message corresponding to the command through the chat room; display command guide information for the chatbot in the chat room; acquire input information for a command based on the command guide information; display a command message comprising the command corresponding to the input information in the chat room; and display a chatbot response message corresponding to the command message in the chat room.

Another aspect is a method for providing command guide information for a chatbot by a server, that include: receiving information for specifying a chatbot from a user terminal, the chatbot providing a chatbot response message corresponding to a command through a chat room; providing the user terminal with command guide information for the chatbot; receiving, from the user terminal, a command message comprising a command input based on the command guide information; and providing the user terminal with a chatbot response message corresponding to the command message.

Another aspect is a server providing command guide information for a chatbot, that includes a memory storing instructions and a processor configured to execute the instructions to: receive information for specifying a chatbot from a user terminal, the chatbot providing a chatbot response message corresponding to a command through a chat room; provide the user terminal with command guide information for the chatbot; receive, from the user terminal, a command message comprising a command input based on the command guide information; and provide the user terminal with a chatbot response message corresponding to the command message.

### BRIEF DESCRIPTION OF THE DRAWINGS

FIG. 1 is a diagram illustrating an example of a network environment according to one embodiment of the present disclosure.

FIG. 2 is a flowchart illustrating a method for a user terminal of the present disclosure to display command guide information for a chatbot through a chat room.

FIGS. 3 to 9 illustrate screens for displaying command guide information for a chatbot through a chat room by a user terminal according to one embodiment of the present disclosure.

FIG. 10 is a flowchart illustrating a method by which a server of the present disclosure provides command guide information for a chatbot.

### DETAILED DESCRIPTION

Users may acquire information quickly and conveniently through chatbots. Specifically, chatbots may automate routine tasks. In addition, users may conveniently acquire information through personalized services and real-time interaction through chatbots. Recently, chatbots may provide more natural conversations thanks to the advancement of artificial intelligence and natural language processing technology.

As chatbots have become more diverse recently, a plurality of chatbots are included in chat rooms. As a plurality of chatbots are included in a chat room, users are having difficulty using the chatbots, so chat room operators are making efforts to increase user convenience with chatbots.

Hereinafter, exemplary embodiments disclosed in this specification will be described in detail with reference to the accompanying drawings. Identical or similar components will be designated by the same reference numerals regardless of the drawing symbols, and redundant descriptions will be omitted. In addition, in the description of the embodiments disclosed in this specification, detailed descriptions of related known technologies will be omitted when it is determined that such descriptions may obscure the gist of the disclosed embodiments.

While terms including ordinal numbers, such as “first” and “second,” etc., may be used to describe various components, such components are not limited by the above terms. These terms are used solely to distinguish one component from another.

The singular forms are intended to include the plural forms, unless the context clearly indicates a different meaning.

In this application, the described steps may be carried out in any sequence, except in cases where a clearly defined cause-and-effect relationship necessitates a specific order.

It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Hereinafter, the present disclosure will be described with reference to the attached drawings.

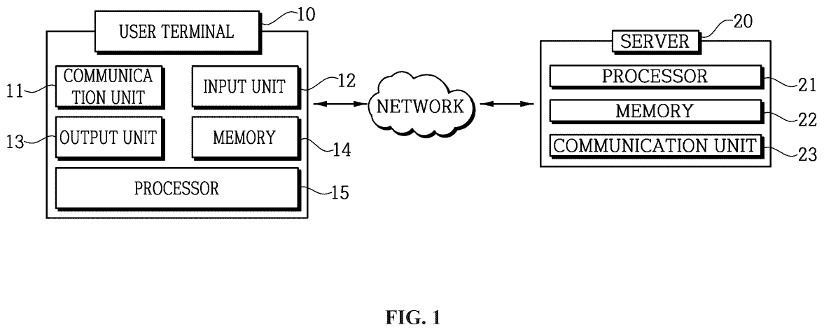

FIG. 1 is a diagram illustrating an example of a network environment according to one embodiment of the present disclosure.

A network environment according to one embodiment of the present disclosure illustrated in FIG. 1 may include a user terminal 10 and a server 20. The user terminal 10 may correspond to at least one terminal connected to the server 20 via a network.

The server 20 may be connected to a user terminal via a network. In addition, the server 20 may be connected to a plurality of user terminals participating in the chat room via a network. The user terminal 10 may be included in a plurality of user terminals participating in a chat room.

Communication schemes for a network are not limited. The communication schemes may include not only a communication scheme to utilize a telecommunication network (for example, a mobile communication network, wired Internet, wireless Internet, and a broadcast network), but also a short-range radio communication scheme.

The user terminal 10 may be a terminal used by logging in with a user account registered in a chat service provided by the server 20.

The user terminal 10 may include a communication unit 11, an input unit 12, an output unit 13, a memory 14, and a processor 15.

The communication unit 11 may communicate with the server 20 or another terminal in a wired or wireless manner.

The input unit 12 may receive various information through the user's manipulation and input actions. The input unit 12 may be a touch screen module, a keyboard, a mouse, a button, a camera, a stylus, a microphone, etc.

The user terminal 10 may receive user interaction through the input unit 12. The interaction refers to a process where a user manipulates the input unit to input information reflecting his or her choices or intentions into the user terminal 10. For example, the interaction may include touching on a touchscreen, clicking with a mouse, typing on a keyboard, providing voice input through a microphone, capturing an image using a camera, recognizing movements through a motion sensor, and the like.

The output unit 13 may output various information. The output unit 13 may be a display device, a speaker, a vibration-generating device, a tactile-generating device, etc. In some cases, the output unit 13 may be a device (e.g., Bluetooth earphones) that is connected to the user terminal 10 through wired or wireless communication (e.g., short-range radio communication such as Bluetooth) to receive and output a signal.

The memory 14 functions as a storage medium and may store a number of application programs running on the user terminal 10, and data and commands for the operation of the user terminal 10. This memory 14 may be provided in the form of any of various hardware storage devices such as a read-only memory (ROM), a random access memory (RAM), a flash drive, a hard drive, etc., or may be provided in the form of a web storage.

In one embodiment, an application related to a chat service may be stored in the memory 14.

The processor 15 may control the overall operation of the communication unit 11, the input unit 12, the output unit 13, and the memory 14 to execute the application related to the chat service.

In the present disclosure, the user terminal 10 may acquire an input for specifying a chatbot through a chat room. Here, the chatbot may provide response messages to commands through the chat room. The user terminal 10 may display command guide information for the chatbot in the chat room and acquire input information for a command based on the command guide information. The user terminal 10 may display a command message including a command corresponding to input information in a chat room, and may display a chatbot response message corresponding to the command message in the chat room.

Here, the chatbot may be a service or application that performs chatting with a user terminal 10. The chatbot generates a message using a programmed message generation method or artificial intelligence, and provides the generated message to the user terminal 10. The user terminal 10 may receive a chatbot message as a spoken message from a chat counterpart.

The chatbot may provide information requested by the user terminal 10 or information related to the user in the form of a chat message. The user terminal 10 and the chatbot may exchange information through mutual interaction, such as chatting. Specifically, the user terminal 10 may request information from the chatbot using a command, and the chatbot may provide information, which is generated in response to the command, in the form of a message.

At least one chatbot may be participating in the chat room. The user terminal 10 may specify one of the chatbots participating in the chat room. The user terminal 10 may specify a chatbot and receive a command for the specified chatbot from the user. For convenience of explanation, in the following description, it is assumed that a plurality of chatbots are participating in a chat room and a user specifies a first chatbot among the plurality of chatbots and inputs a command for the first chatbot.

Here, a command message refers to a message that the user inputs to request information for specifying a chatbot. The command message may include information for specifying the chatbot and a command for the chatbot. The command message may be displayed in a message display window of the chat room, just like any other chat message spoken by a user account.

Here, the command guide information refers to an interface that allows a user to quickly and easily input a command for a specific chatbot. Since it may be difficult for the user to directly input a command for the specific chatbot by typing or other input methods, the user terminal 10 may be provided with command guide information that shows key commands for the specific chatbot in the form of options or the like. The user may input a command simply by selecting one of the command options included in the command guide information.

Here, a chatbot response message refers to a message from the chatbot provided in response to a command message. The content of the chatbot response message may be determined depending on a command included in the command message. For example, for a chatbot that provides news information, if the command ‘Economic News’ is input, the chatbot may provide a chatbot response message about news information related to the economy.

The server 20 may be implemented as a computer device or a plurality of computer devices that provide commands, codes, files, contents, services, and the like. The server 20 may transmit and receive information through communication with the user terminal 10 via a network.

The server 20 may include a processor 21, a memory 22, and a communication unit 23.

The processor 21 controls the overall operation of the memory 22 and the communication unit 23 to provide the user terminal 10 with a chat service including a chatbot service. The chatbot service may be a service in which when a user inputs a command message to a chatbot through a chat room, the chatbot displays a chatbot response message corresponding to the command message.

The memory 22 functions as a storage medium and may store a number of application programs running on the server 20, and data and commands for the operation of the server 20. In one embodiment, the memory 22 may store an application program that provides a chat service.

This memory 22 may be provided in the form of any of various hardware storage devices such as a read only memory (ROM), a random access memory (RAM), a flash drive, hard drive, etc., or may be provided in the form of a web storage.

The communication unit 23 may communicate with the user terminal 10 via a network in a wired or wireless manner.

The server 20 of the present disclosure may provide a chat service including a chatbot service to the user terminal 10.

In the present disclosure, the server 20 may receive information for specifying a chatbot from the user terminal 10, provide the user terminal 10 with command guide information for the chatbot, receive from the user terminal 10 a command message including a command input based on the command guide information, and provide the user terminal 10 with a chatbot response message corresponding to the command message.

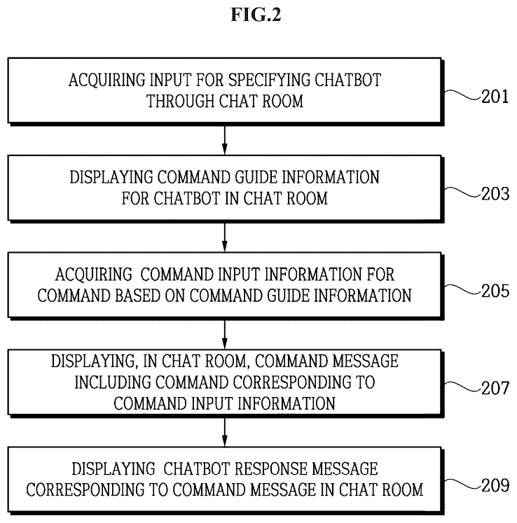

Hereinafter, one embodiment of a method for displaying command guide information for a chatbot by a user terminal 10 of the present disclosure will be described with reference to FIGS. 2 to 9.

FIG. 2 is a flowchart illustrating a method for displaying a chatbot response message through a chat room by the user terminal 10 of the present disclosure.

In operation 201, the user terminal 10 acquires an input for specifying a chatbot through a chat room.

At least one chatbot may be participating in the chat room. The chatbot participating in the chat room may be a default chatbot that the server 20 provides through the chat room or a chatbot invited upon a request from a user account. Before the user inputs a command for the chatbot, the chatbot to which the command is directed may be specified. Hereinafter, an example in which the user inputs a command with a first chatbot is specified among chatbots participating in a plurality of chat rooms.

The user terminal 10 may acquire an input for specifying a chatbot by various methods.

For example, the user terminal 10 may acquire information for specifying the chatbot through a message input field of the chat room. The information for specifying the chatbot may be a name, an identifier, or predefined symbol of the chatbot. The information for specifying the chatbot may include a specific symbol (e.g., @) to distinguish the information for specifying the chatbot from regular chat messages input through the message input field. Such a specific symbol may be placed at the very beginning of the information for specifying the chatbot. The user terminal 10 may display the information for specifying the chatbot in a different size, color, or font to distinguish such information from regular chat messages.

The user may input the information for specifying the chatbot into the message input field. Specifically, the user may input the information for specifying the chatbot through keyboard typing or the like in a message input field. The user may input the information for specifying the chatbot by pasting information saved in a clipboard or using voice input.

As another example, the user terminal 10 may acquire the information for specifying the chatbot using list information about participating chatbots that are participating in the chat room. The user terminal 10 may display the list information about participating chatbots in the chat room upon a user's request. For example, the user may request the list of participating chatbots in the chat room by inputting a specific predefined symbol (e.g., @) into the message input field. In some cases, the user terminal 10 may display commands for the participating chatbot in the chat room, together with the list information.

A manner in which the list of participating chatbots is displayed may be determined based on at least one of chat history of the chat room and a command usage history of the user. For example, the order in which chatbots are displayed in the list of participating chatbots may be based on at least one of a chat history of the chat room and a command usage history of the user. For example, if a recent chat message includes content related to stocks, the user terminal 10 may display a chatbot (StockBot) that provides information related to stocks with the highest priority. In addition, if the user has frequently used a command related to “Newsbot,” the user terminal 10 may display “Newsbot” with the highest priority.

The user may input a selection interaction for a specific chatbot from list information about chatbots.

As another example, the user terminal 10 may acquire an input made in a chat room with respect to utterance information of a chatbot, as an input for specifying a chatbot. Here, the utterance information of the chatbot may include at least one of a spoken message and speaker information of the chatbot.

Specifically, the user terminal 10 may acquire an input for replying to a spoken message from the chatbot, as an input for specifying the chatbot. Before operation 201 is performed, a spoken message from the chatbot may be transmitted through the chat room. The user may input a command for the chatbot by replying to the spoken message from the chatbot displayed in the chat room. Accordingly, the user terminal 10 may acquire the user's reply interaction to the spoken message from the chatbot as an input for specifying the chatbot.

In addition, the user terminal 10 may acquire an input for speaker information of the chatbot (such as a display name or profile image of the chatbot) as an input for specifying the chatbot. Before operation 201 is performed, the speaker information of the chatbot may be displayed when the spoken message from the chatbot is displayed in the chat room. The user may input a command for the chatbot by inputting an interaction with the speaker information of the chatbot. Accordingly, the user terminal 10 may acquire the user's interaction with the speaker information of the chatbot as an input for specifying the chatbot.

In some cases, the speaker information of the chatbot may include a chatbot call interface displayed in the chat room. The chatbot call interface may be an interface for specifying the chatbot before the user inputs a command for the chatbot. The chatbot call interface may be displayed in response to the spoken message from the chatbot. Specifically, when the spoken message from the chatbot is displayed in the message display window of the chat room, the chatbot call interface for the chatbot may be displayed. Since the chatbot call interface is based on the message display window currently displayed by the user terminal 10, if the message display window is scrolled and a displayed message changes, the displayed chatbot call interface may also change. For example, while the user terminal 10 displays spoken messages from the first chatbot and the second chatbot in the message display window, the user terminal 10 may display chatbot call interfaces for each of the first chatbot and the second chatbot in a portion of the message display window.

By the above-described method, when a chatbot is specified through a chat room, the user terminal 10 may display information related to the specified chatbot. Specifically, the user terminal 10 may display information for specifying a chatbot in a message input field of the chat room. In addition, in some cases, the user terminal 10 may display a pop-up message such as “The first chatbot has been specified” around the message input field of the chat room.

In operation 203, the user terminal 10 displays command guide information for the chatbot in the chat room.

The command guide information may be provided in various forms to allow the user to quickly and easily input a command for the specified chatbot.

For example, the command guide information may include guidance regarding commands for a chatbot. For example, command guide information for a chatbot that provides stock information may include guidance regarding commands, such as “Enter a ticker as a chatbot command to receive real-time information on that ticker.”

As another example, the command guide information may be displayed as command options to allow the user to quickly input a command. The user may input a command simply by selecting one of a plurality of command options. When selection information for a specific command option is acquired from the user, the user terminal 10 may display a command corresponding to the selected command option in the message input field.

A command included in the command option may be an information request command to request information from the chatbot or a setting command to input a configuration setting of the chatbot. For example, the setting command may refer to a command for inputting customized information related to the chatbot or a command for inputting a configuration setting for message delivery by the chatbot. When the command is an information request command, a chatbot response message corresponding to the command may be a message about the requested information. However, when the command is a setting command, a chatbot response message corresponding to the command may be a message about the configuration settings of the chatbot. The chatbot response message for the requested information and the chatbot response message for the configuration setting may be displayed differently in the chat room.

Hereinafter, for convenience of explanation, the command guide information will be illustrated using an example in which a plurality of command options are displayed.

The command options may be stored in the user terminal 10. Specifically, the user terminal 10 may provide the user with the command options in response to a request to display command options. In some cases, the command options may be stored on the server 20. In this case, the user terminal 10 may receive the command options from the server 20 and display the command options.

A manner in which the plurality of command options is displayed may be determined based on history information. Specifically, a manner in which the plurality of command options is displayed may be determined based on a chat history of the chat room or a command usage history of the user. Here, the manner in which the plurality of command options is displayed may refer to a display order of the command options, a display priority among the command options, a recommendation indicator for any of the command options, etc. For example, if the user has frequently used a specific command for a particular chatbot, a command option for the frequently used command may be displayed with priority over other command options.

In some cases, the manner in which a plurality of command options is displayed may be determined based on information set by the operator who provides the chatbot service. For example, the order in which the plurality of command options is displayed may be set by the operator.

The command options may be provided in multiple steps. Specifically, when the user terminal 10 acquires selection information for a primary command option from the user, the user terminal 10 may display secondary command options determined based on the selection information.

For example, if a specific chatbot is “GolfBookingBot” that performs a golf course reservation function, the user terminal 10 may display three command options, such as “Book,” “Change Booking,” and “Nearby Search,” as primary command options. When the user terminal 10 acquires an interaction for selecting “Book” among the primary command options, the user terminal 10 may display four command options, such as “Seoul,” “Gyeonggi,” “Busan,” “Jeju Island” and “Gwangju,” as secondary command options based on “Book.”

In the above example, if a chat history related to “Jeju Island Golf Trip” is identified in the recent chats in the chat room, “Jeju Island” among the user's secondary command options may be displayed with the highest priority.

The user terminal 10 may display the command guide information near the message input field of the chat room. The command guide information may be displayed without overlapping with other message-input-related interfaces in the chat room. For example, when a chatbot is specified while an emoticon preview interface is displayed in the message input field of the chat room, command guide information may be displayed so as not to overlap with the emoticon preview interface. For example, the command guide information may be displayed between the emoticon preview interface and the message input field.

In operation 205, the user terminal 10 acquires input information for a command based on the command guide information.

In operation 203 described above, the user terminal 10 may display the command guide information including a command input interface. In operation 205, the user terminal 10 may acquire an interaction with the command input interface. Here, the interaction with the command input interface may be input information for a command.

In the above example, the command input interface may be a plurality of command options, and the input information for the command may be selection information for a command option. When the input information for the command is acquired, the command guide information may no longer be displayed.

When the user terminal 10 acquires the input information for the command, the user terminal 10 may display the command corresponding to the input information in the message input field of the chat room. As described above, as the chatbot is specified in operation 201, the information for specifying the chatbot may be displayed in the message input field. In this case, the command corresponding to the input information in operation 205 may be displayed in the message input field, together with the information for specifying the chatbot.

For example, when a chatbot is specified based on specification information, such as “StockBot” (the chatbot's name), the message input field may display information such as “@StockBot” (operation 201). Then, command guide information for “StockBot” may be displayed (operation 203). Then, when input information for “Today's stock price information” is acquired through the command guide information, the message input field may display information such as “@StockBot Today's stock price information” (operation 205).

In operation 205, the state in which the input information for the command is acquired and the command is displayed in the message input field may indicate that the user terminal 10 have not yet transmitted information on the command to the server 20. In operation 205, the state in which the command is displayed in the message input field may indicate that the command message to be transmitted in operation 207 has been input to the message input field but has not yet been transmitted to the server 20.

In some cases, instead of operation 205, acquiring input information for a command may be performed through a method other than using the command guide information.

For example, the method for inputting a command without using the command guide information may be inputting the command directly into the message input field of the chat room. Specifically, the user may input a command to the chatbot through a keyboard typing interaction or the like in the message input field of the chat room. In addition, the user may input a command to the chatbot by pasting information saved on a clipboard or using voice input.

Even though the user terminal 10 is displaying command guide information, if input information for a command is acquired through a method other than using the command guide information, the user terminal 10 may stop displaying the command guide information. For example, when the user terminal 10 receives the input information for the command directly from the user through the message input field, the user terminal 10 may stop displaying the command guide information.

In some cases, even when the user moves the mouse cursor into the command input area of the message input field to type a command directly into the message input field, the user terminal 10 may stop displaying the command guide information.

In operation 207, the user terminal 10 displays, in the chat room, the command message including the command corresponding to the input information.

The command message may include information for specifying the chatbot and the command based on input information. As in the example described above, the command message may begin with the information for specifying the chatbot, followed by the command corresponding to the input information. In a state where the command message is displayed in the message input field in operation 205, the user terminal 10 may acquire a send interaction from the user to transmit the command message displayed in the message input field to the server 20.

In response to the send interaction, the user terminal 10 may transmit the command message to the server 20 and display the command message in the message display window. The command message displayed in the message display window may be displayed in the form of a spoken message from the user.

In operation 209, the user terminal 10 displays a chatbot response message corresponding to the command message in the chat room.

When the user terminal 10 transmits the command message to the server 20 in operation 207, the user terminal 10 may receive the chatbot response message corresponding to the command message from the server 20. The user terminal 10 may display the chatbot response message in the chat room in the form of a spoken message from the chatbot.

In some cases, the chatbot response message may include additional command guide information where an additional command for the chatbot can be input. The user terminal 10 may transmit an additional command for the chatbot to the server 20 through the additional command guide information.

The additional command guide information may be included in the chatbot response message or displayed near the chatbot response message (e.g., under the chatbot response message) in the message display window of the chat room. Accordingly, the additional command guide information may be displayed as subordinate to the chatbot response message. If there are a plurality of response messages spoken by the chatbot, the additional command guide information may be displayed only in response to the last response message from the chatbot.

The additional command guide information may be identical to the command guide information displayed in operation 203. However, in some cases, the additional command guide information may be different from the command guide information displayed in operation 203. For example, the additional command guide information may exclude the command acquired in operation 205 from the command guide information displayed in operation 203. This is because the chatbot response message corresponding to the command acquired in operation 205 has already been provided together with the additional command guide information, and therefore, it may be unnecessary to provide the command again in the additional command guide information.

For example, a specific chatbot may be “StockBot” and three command options “Local Trending,” “Global Trending,” and “Ticker Discussion” may be provided as command guide information. When the user terminal 10 acquires the command “Local Trending,” the user terminal 10 may display a chatbot response message corresponding to the command “Local Trending” and may also display, as additional command guide information, command options including “Global Trending” and “Ticker Discussion,” excluding “Local Trending.”

In some cases, the order in which the command options included in the additional command guide information are displayed may be determined based on the command acquired in operation 205. For example, a command option for a frequently used command may be displayed after the command acquired in operation 205, or a command option for the command acquired in operation 205 may be displayed with a lower priority.

In some cases, the additional command guide information may be guide information for inputting a subsequent (secondary) command after the command acquired in operation 205. Specifically, the additional command guide information may be displayed similarly to how the command options described in operation 203 are provided in multiple steps.

Referring to the example of operation 203, the user terminal 10 may display three command options, including “Book,” “Change reservation,” and “Search nearby” and acquire input information for the option “Book.” Unlike the example in operation 203, the input information for the option “Book” may be input information for the command “Book,” rather than selection information for a primary command option. Accordingly, in operation 205, the user terminal 10 may display a chatbot response message corresponding to the command “Book.” Here, the chatbot response message may be displayed with four command options of “Seoul,” “Gyeonggi,” “Busan,” “Jeju Island,” and “Gwangju.”

In some cases, the additional command guide information may be for a setting command used to input a configuration setting of the chatbot. The setting command refers to a command that determines or modifies a configuration setting of the chatbot. The setting command may be distinguished from an information request command that requests specification information from the chatbot.

Unlike the information request command, only a first interaction for the setting command from any one of a plurality of user terminals participating in the chat room may be validly processed. When the information request command is repeatedly selected, the server 20 may repeatedly provide the information on the command. However, since repeated changes to the chatbot's configuration settings due to repeated selection of the setting command are not desirable, the server 20 may process only the first setting command input in the chat room as valid. Thereafter, the server 20 may disable selection of the setting command.

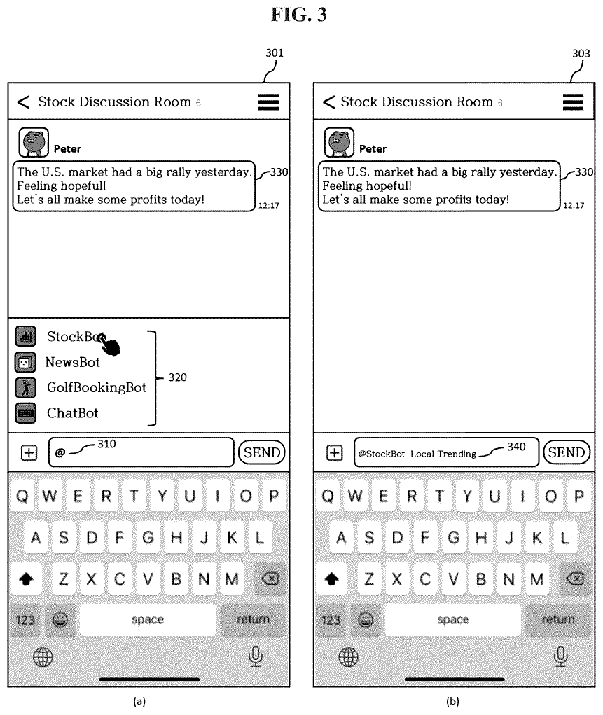

Hereinafter, an example of a method for displaying command guide information for a chatbot by a user terminal 10 of the present disclosure will be described with reference to FIGS. 3 to 9.

FIG. 3 illustrates a screen where the user terminal 10 according to one embodiment of the present disclosure specifies one of at least one chatbot 320 participating in a chat room 300.

In FIG. 3, (a) illustrates a screen showing how to specify a chatbot (StockBot) using list information 320 about participating chatbots. In FIG. 3, (b) illustrates a screen where information for specifying a chatbot is displayed in a message input field.

Referring to (a) of FIG. 3, a plurality of chatbots 320 may be participating in the chat room 300. The user terminal 10 may acquire an input 310 from a user to display list information about the participating chatbots in the chat room 300. For example, an input to display list information about participating chatbots may be a user inputting a specific symbol (e.g., @) 310 into the input field.

The user terminal 10 may display the list information 320 about the participating chatbots in one area of the chat room in response to the input of the specific symbol 310. Here, the order in which the list information 320 about the participating chatbots is displayed may be based on at least one of a chat history of the chat room 300 and a command usage history of the user.

For example, content related to stocks, such as “The U.S. market had a big rally yesterday. Feeling hopeful! Let's all make some profits today!” 330, may be included in the recent chat history of the user terminal 10. In this case, when displaying the list 320 of the participating chatbots, the user terminal 10 may display “StockBot” with the highest priority.

When the user inputs a selection interaction with “StockBot” in (a) of FIG. 3, the user terminal 10 may display specification information 340 about “StockBot” in the message input field, as shown in (b) of FIG. 3.

In some cases, the user terminal 10 may not display the list information 320 as shown in (a) of FIG. 3, but may receive the specification information 340 about “StockBot” directly from the user through keyboard typing or the like to specify a chatbot.

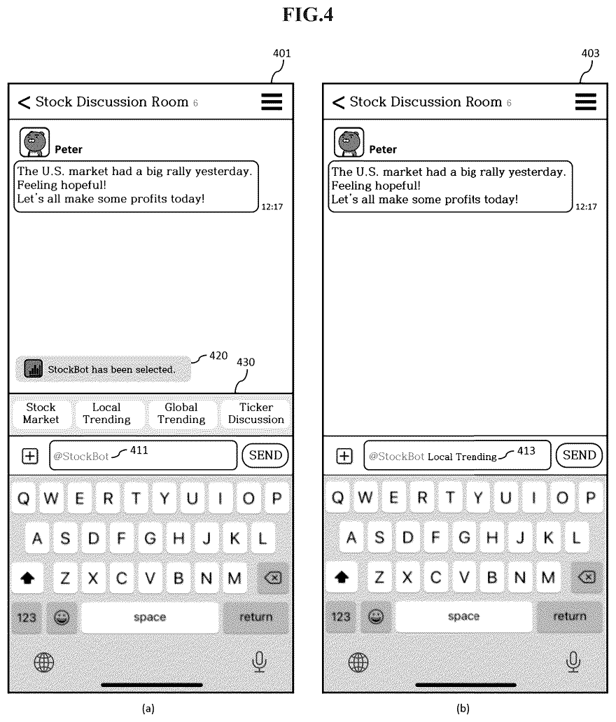

FIG. 4 illustrates a screen where the user terminal 10 displays command guide information 430 according to one embodiment of the present disclosure.

In FIG. 4, (a) illustrates a screen showing how to display specification information 411 and the command guide information 430 for “StockBot” according to an input for specifying “StockBot.” In FIG. 4, (b) illustrates a screen showing how to display a command message 413 in a message input field using command options 430.

In FIG. 4, (a) may be displayed in response to selection information for “StockBot” among at least one chatbot 320 in FIG. 3. Referring to (a) of FIG. 4, when “StockBot” is specified, the user terminal 10 may display information 411 for specifying “StockBot” and information 420 related to the specification of “StockBot.”

The user terminal 10 may display information 411 for specifying “StockBot” in response to an input for specifying “StockBot.” For example, the user terminal 10 may display the information 411 for specifying “StockBot” in a different color, size, or font from other texts in the message input field.

In addition, the user terminal 10 may display a pop-up message such as “StockBot has been selected” 420 in an area of a chat room 401 in response to the input for specifying “StockBot.”

When “StockBot” is specified, the user terminal 10 may display the command guide information 430 for “StockBot.” Specifically, the user terminal 10 may display command options 430 such as “Stock Market,” “Local Trending,” “Global Trending,” and “Ticker Discussion” as the command guide information for “StockBot.”

When selection information for one of the command options 430 is received from the user, the user terminal 10 may display a command 413 corresponding to input information in the message input field.

Referring to (b) of FIG. 4, the command guide information 430 is not displayed, unlike as shown in (a) of FIG. 4. This may be because the user terminal 10 has acquired selection information for the interface “Local Trending” among the command options 430 shown in (a) of FIG. 4, thereby stopping the display of the command guide information 430.

In FIG. 4, (b) may show a result of the user terminal 10 receiving input information for the command “Local Trending” 413 from the user. Specifically, the user may have selected “Local Trending” command option from among a plurality of command options 430, and the user may have directly input a text “Local Trending” 413 into the message input field through keyboard typing.

Accordingly, the user terminal 10 may display a command message (@StockBot Local Trending) in which information for specifying the chatbot (@StockBot) and the input command (Local Trending) are sequentially input into the message input field.

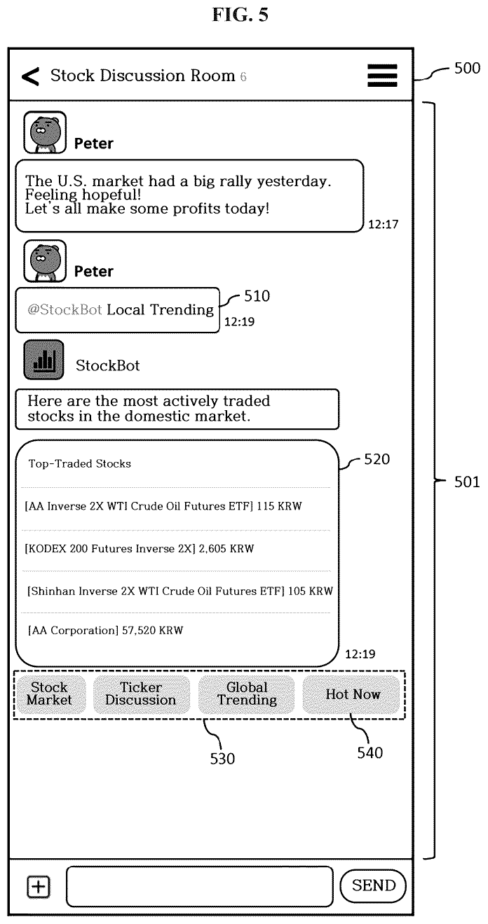

FIG. 5 illustrates a screen where the user terminal 10 according to one embodiment of the present disclosure displays a chatbot response message 520 to a command.

FIG. 5 may be displayed in response to a request to transmit an input message (@StockBot Local Trending) to a chat room 500, as shown in FIG. 4.

Referring to FIG. 5, the user terminal 10 may display the chatbot response message 520 to the command “@StockBot Local Trending” 510. Here, the chatbot response message 520 may be displayed as a spoken message from “StockBot.”

The user terminal 10 may display additional command guide information 530 in a message display window 501, together with a chatbot response message 520. Specifically, when displaying the chatbot response message 520, the user terminal 10 may display additional command guide information 530 under the chatbot response message 520. The additional command guide information 530 may only be displayed under the last spoken message from a specific chatbot. The determination of whether a message is the last spoken message may be made independently for each chatbot.

For example, if a chatbot response message (previous message) to a different command precedes the command “@StockBot Local Trending” (the last message) from “Stockbot,” the additional command guide information 530 may not be displayed below the previously spoken response message (previous message).

The additional command guide information 530 may include command options for commands other than a command corresponding to input information. For example, the user terminal 10 may display a command message corresponding to input information such as “@StockBot Local Trending” 510 in the message display window 501. In this case, the user terminal 10 may display command guide information 530 that includes other command options, such as “Hot Now” 540, excluding “Local Trending.”

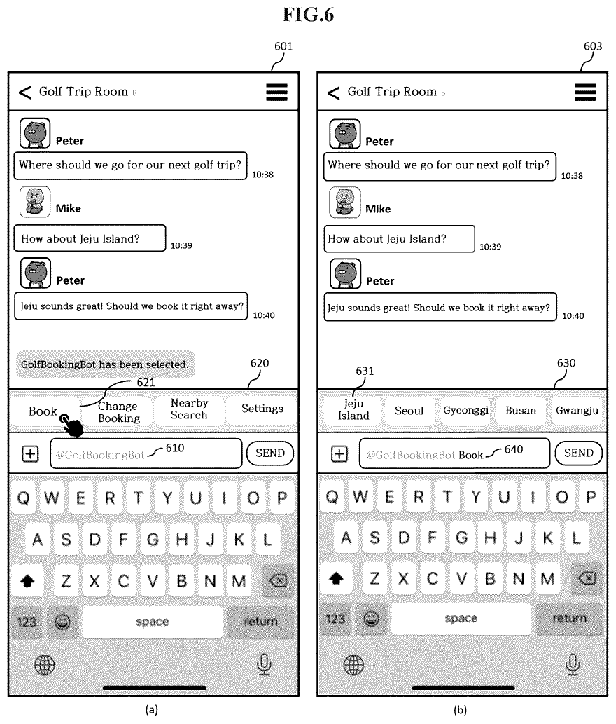

FIG. 6 illustrates a screen where the user terminal 10 according to one embodiment of the present disclosure displays command guide information in multiple steps.

FIG. 6 may be displayed in response to an input for specifying “@GolfBookingBot” 610.

Referring to FIG. 6, the user terminal 10 may display primary command options 620 in a chat room 600 in response to the input for specifying “GolfBookingBot” 610. The user terminal 10 may acquire selection information for one of the primary command options 620 from the user.

Here, the order in which the primary command options 620 are displayed may be based on at least one of a chat history of the chat room 600 and a command usage history of the user. For example, if Peter most frequently selected the command option “Book” 621, the user terminal 10 may display the command option “Book” 621 among the primary command options 620 with higher priority.

When the user terminal 10 acquires selection information for the command option “Book” 621, which is one of the primary command options 620, the user terminal 10 may display a secondary command guide information 630 in the chat room 600.

The order in which the secondary command options 630 are displayed may be based on at least one of a chat history of the chat room 600 and a command usage history of the user. For example, when a recent chat history such as Peter's “Where should we go for our next golf trip?,” Mike's “How about Jeju Island?,” and Peter's “Jeju sounds great! Should we book it right away?” is identified, the user terminal 10 may display the option “Jeju Island” 631 with higher priority among the secondary command options 630.

When selection information for the option “Book” 621 is acquired from the user, the user terminal 10 may display a command such as “Book” in a message input field of the chat room 600. For example, when selection information for the option “Book” 621 option while “@GolfBookingBot” is input, the user terminal 10 may display a command such as “@GolfBookingBot Book” 640 in the message input field of the chat room 600.

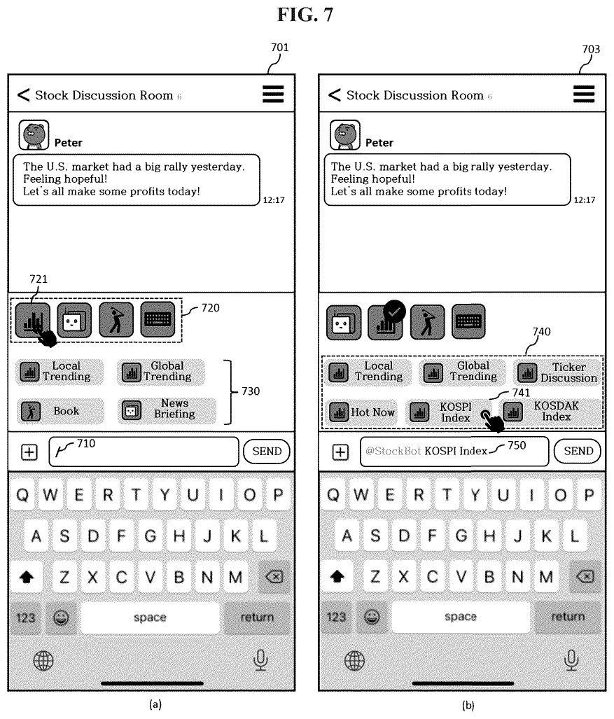

FIG. 7 illustrates a screen where the user terminal 10 according to one embodiment of the present disclosure displays list information 731 about chatbots participating in a chat room 701.

In FIG. 7, (a) illustrates a screen showing how to specify StockBot 721 through list information 720 about participating chatbots in the chat room 701.

In FIG. 7, (b) illustrates a screen showing how to display guide information 740 for “StockBot.”

Referring to (a) of FIG. 7, the user terminal 10 may display the list information 720 about the participating chatbots in response to an input 710 for displaying the list information 720 about the participating chatbots. Here, the input for displaying the list information may be a specific symbol (e.g., /) 710 input by the user.

The user terminal 10 may display command guide information 730 for a participating chatbot around the list information 720. How to display the chatbot list 720 and the command guide information 730 may vary depending on a chat history of the chat room 700 and a command usage history of the user.

For example, the order in which the chatbot list 720 is displayed may be based on the chat history of the chat room 700. Specifically, when a recent chat history such as Peter's “The U.S. market had a big rally yesterday. Feeling hopeful! Let's all make some profits today!” is identified in the chat room 700, the user terminal 10 may display the commands “Local Trending” and “Global Trending” from StockBot with priority over other command options.

As another example, the command guide information 730 may only display commands 730 that have been recently used by the user. Specifically, if the user terminal 10 has recently used commands such as “@StockBot Local Trending,” “@StockBot Global Trending,” “@GolfReservationBot Book” and “@NewsBot News Briefing,” the user terminal 10 may display only the recently used commands 730 based on an input for displaying a command.

The user terminal 10 may acquire selection information for “StockBot” among chatbots displayed in the list information 720 from the user.

Referring to (b) of FIG. 7, when the user terminal 10 acquires selection information for “StockBot,” the user terminal 10 may only display commands 740 for “StockBot.” For example, when the user terminal 10 receives selection information for “StockBot” shown in (a) of FIG. 7 from the user, the user terminal 10 may only display the commands 740 for “StockBot” such as “Local Trending,” “Global Trending,” and “Ticker Discussion.”

In addition, when the user terminal 10 acquires selection information for the option “KOSPI Index” 741 from the command guide information displayed in one area of the chat room from the user, the user terminal 10 may display input information for a command such as “@StockBot KOSPI Index” 750 in the message input field. Thereafter, the user terminal 10 may display a command message including the input information 750 in the chat room in response to a request to transmit the input information 750 to the chat room.

In some cases, when the user terminal 10 acquires selection information for the option “KOSPI Index” 741 from the user, the user terminal 10 may display a command message corresponding to the option “KOSPI Index” 741 in the chat room, without displaying input information for the command such as “KOSPI Index” 741 in the message input field.

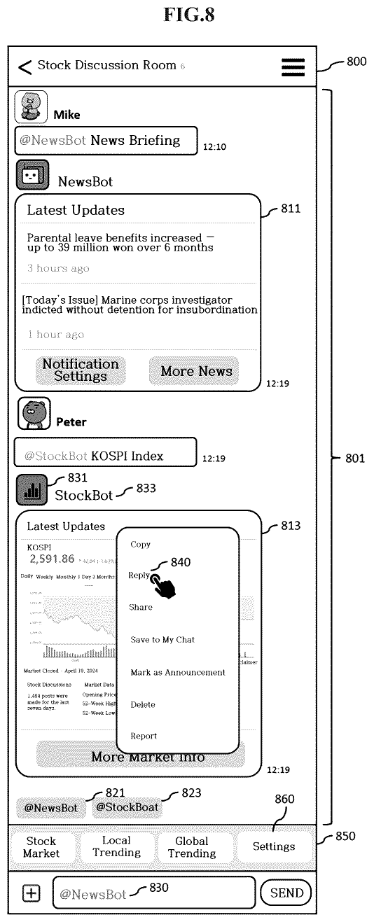

FIG. 8 illustrates a screen where the user terminal 10 displays utterance information 811, 813, 821, 823, 831, and 833 according to one embodiment of the present disclosure.

FIG. 8 may be displayed in response to a request to send a command message 750 to a chat room in FIG. 7.

Referring to FIG. 8, the user terminal 10 may display the utterance information 811, 813, 821, 823, 831, and 833. Here, the utterance information may include spoken messages 811 and 813 from chatbots, chatbot call interfaces 821 and 823, a speaker name (display name) 833, and a profile image 831.

The chatbot call interfaces 821 and 823 may be displayed in response to the spoken messages 811 and 813 displayed in a message display window 801. For example, if the user terminal 10 is displaying the spoken messages from “Newsbot” and “Stockbot” in the message display window 801 of a chat room 800, the user terminal 10 may display the chatbot calling interfaces 821 and 823 configured to call the “Newsbot” and “Stockbot.” Here, if the message display window 801 in the screen of FIG. 8 is scrolled so that the spoken message 811 from “Newsbot” is no longer displayed, the chatbot call interface 821 for “Newsbot” may be no longer displayed.

Each of the chatbot call interfaces 821 and 823 may include at least one of a name and a profile image of a corresponding chatbot. Specifically, the chatbot call interface 823 may display only the profile name of “StockBot,” as shown in FIG. 8. However, in some cases, the chatbot call interface 823 may display the profile image information of “StockBot” together, in contrast to what is shown in FIG. 8.

The user terminal 10 may specify “StockBot” by acquiring at least one of an input 840 for replying to the spoken message 813 from “StockBot” and an input for the speaker information 823, 831, and 833 of “StockBot.”

When the user terminal 10 specifies “StockBot,” the user terminal 10 may display command guide information 850 for “StockBot.” The command guide information 850 may include an interface 860 related to settings of a chatbot. As an example, the interface related to settings of a chatbot may be displayed as primary command options 860, and an interface related to settings of a specific chatbot may be displayed as secondary command options.

When the user terminal 10 acquires an interaction from the user with the option ‘Settings’ 860, the user terminal 10 may display secondary command options 910 related to settings of the chatbot.

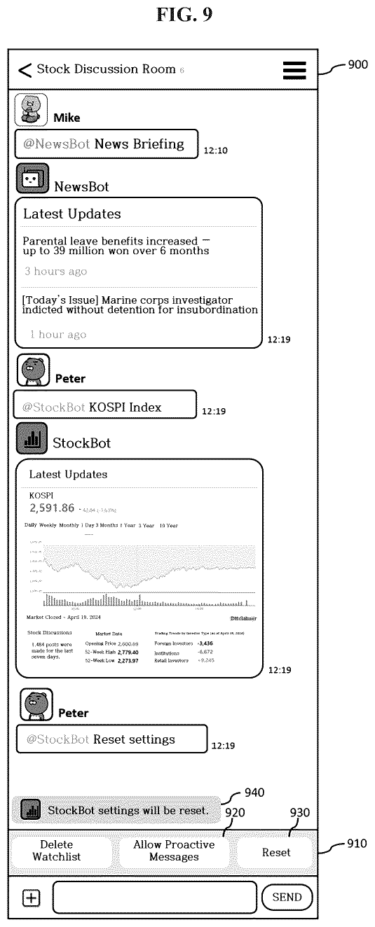

FIG. 9 illustrates a screen where the user terminal 10 according to one embodiment of the present disclosure displays the secondary command options 910 related to settings of a chatbot.

FIG. 9 may be displayed by an interaction with the option ‘Settings’ 860 in FIG. 8.

Referring to FIG. 9, the user terminal 10 may display an interface related to settings of a chatbot. Here, the interface related to settings of a chatbot may be displayed in the form of secondary command options.

The interface related to settings of a chatbot may include at least one of whether to allow a proactive message that is not a response to a command message and whether to allow an interface for resetting settings of the chatbot.

The user terminal 10 may decide whether to allow a proactive message from the chatbot. A proactive message refers to a message that is not a response to a command message from the user terminal 10. If proactive messaging is allowed, the server 20 may proactively send a chatbot message to the user terminal 10 at a specific time or upon satisfaction of a specific condition even if the user terminal 10 does not transmit a command message to the server 20.

Specifically, the user terminal 10 may determine whether to allow a proactive message from the chatbot through an interface 920 for allowing a proactive message from the chatbot. For example, the user terminal 10 may be set to allow a proactive message from “StockBot.” In this case, if the server 20 identifies chat content related to stocks rather than a command message from the user terminal 10 through the chat room, the server 20 may provide a proactive message from StockBot to the chat room in the form of a spoken message from “StockBot.”

The user terminal 10 may reset settings through the interface 930 for resetting configuration settings of the chatbot. Here, resetting the configuration setting may refer to an operation of returning data setting values configured for the chatbot to initial values. For example, when the user terminal 10 inputs a command message such as “@StockBot Reset settings,” the data setting values configured for “StockBot” may return to the initial values set for “StockBot.”

Unlike other command messages, the command message for resetting configuration settings may not be displayed in a chat room message display window. Specifically, the user terminal 10 may send a command message to the chat room to reset the settings of the chatbot. In this case, the server 20 may not provide a chatbot response message corresponding to the command message to the user terminal 10, but may provide a pop-up message such as “StockBot settings will be reset” 940.

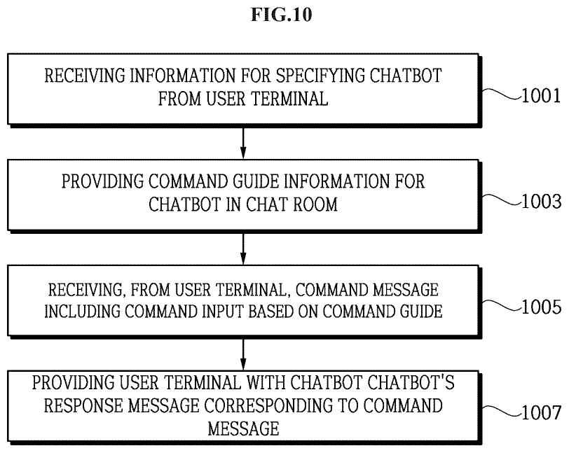

FIG. 10 is a flowchart illustrating a method for providing command guide information for a chatbot by a server 20 of the present disclosure.

For convenience of explanation, the description of operations in FIG. 10 that are substantially the same as the operations in FIG. 2 will be replaced with a description referring to FIG. 2.

In operation 1001, the server 20 receives information for specifying a chatbot from the user terminal 10. Since operation 1001 is substantially the same as operation 201 of FIG. 2, the description of operation 1001 will be replaced with a description of operation 201 of FIG. 2.

In operation 1003, the server 20 provides command guide information for a chatbot to a chat room. Since operation 1003 is substantially the same as operation 203 of FIG. 2, the description of operation 1003 will be replaced with a description of operation 203 of FIG. 2.

In operation 1005, the server 20 receives a command message including a command input based on the command guide information from the user terminal 10. Since operation 1005 is substantially the same as operation 205 and operation 207 of FIG. 2, the description of operation 1005 will be replaced with a description of operation 205 and operation 207 of FIG. 2.

In operation 1007, the server 20 provides a chatbot response message corresponding to the command message to the user terminal 10. In operation 1007, any content substantially identical to operation 209 of FIG. 2 will be described by referring to operation 209 of FIG. 2.

Unlike operation 1007, in some cases, the server 20 may provide a proactive message from the chatbot even if any command message is received from the user terminal 10.

Specifically, the server 20 may provide the user terminal 10 with an interface related to whether to allow a proactive message from the chatbot. When an interface related to whether to allow a chatbot is set to allow, the server 20 may display a spoken message from a first chatbot through the chat room upon identifying chat content related to the chatbot, even if no command message for the chatbot is received from the user terminal 10.

For example, when the server 20 identifies chat content related to “Jeju Island golf trip” through the chat room, the server 20 may provide a spoken message from GolfBookingBot such as “Would you like to receive a Jeju Island golf course recommendation?” to the chat room.

In some cases, the proactive message may be an advertising message from the chatbot. In this case, the server 20 may provide the proactive message from the chatbot to the user terminal 10, regardless of the chat content.

According to the present disclosure, one chatbot among a plurality of chatbots may be specified through a chat room, and guide information on commands included in the chatbot may be provided to the user, thereby allowing the user to conveniently use the chatbot.

According to the present disclosure, based on the specification of a chatbot, command guide information may be provided to the user, and when the user inputs a command message, a chatbot response message corresponding to the command may be provided through the chat room.

The technical features disclosed in each embodiment of the present disclosure are not limited to a corresponding embodiment, and unless incompatible with each other, the technical features disclosed in each embodiment may be applied in combination to other embodiments.

Therefore, although each embodiment is described mainly about an individual technical feature, the technical features of the embodiments of the present disclosure may be applied in combination, unless incompatible with each other.

The present disclosure is not limited to the above-described embodiments and the accompanying drawings, and various modifications and changes may be made in view of a person skilled in the art to which the present disclosure pertains. Therefore, the scope of the present disclosure should be determined by the scope of the appended claims, and equivalents thereof.

What is claimed is:

1. A method for displaying command guide information for a chatbot by a user terminal, comprising:
acquiring an input for specifying a chatbot through a chat room, the chatbot providing a chatbot response message corresponding to the command through the chat room;
displaying command guide information for the chatbot in the chat room;
acquiring input information for a command based on the command guide information;
displaying a command message comprising the command corresponding to the input information in the chat room; and
displaying a chatbot response message corresponding to the command message in the chat room.

2. The method of claim 1, wherein displaying the command guide information comprises:
displaying at least one primary command option;
acquiring selection information for at least one primary command option from a user; and
displaying at least one secondary command option determined based on the selection information.

3. The method of claim 1, wherein:
displaying the command guide information comprises displaying at least one command option, and
a manner in which the at least one command option is displayed is determined based on at least one of a chat history of the chat room and a command usage history of the user.

4. The method of claim 1, further comprising:
displaying the command corresponding to the input information in a message input field of the chat room, wherein displaying the command is performed between the acquiring of the input information and the displaying of the command message.

5. The method of claim 4, further comprising:
displaying information for specifying the chatbot in the message input field, wherein displaying the information for specifying the chatbot is performed between the acquiring of an input for specifying the chatbot and the acquiring of the input information,
wherein in displaying the command, the command is displayed in the message input field together with the information for specifying the chatbot.

6. The method of claim 4, wherein displaying the command message comprises:
acquiring a user's interaction for sending the command message displayed in the message input field; and
displaying the command message in a message display window of the chat room.

7. The method of claim 1, further comprising:
acquiring input information for a command through a typing interaction on a message input field of the chat room, wherein the acquiring of the input information for the command is performed instead of the acquiring of the input information based on the command guide information.

8. The method of claim 1, further comprising:
stopping the displaying of the command guide information when input information for a command is acquired through a method other than using the command guide information, wherein the stopping of the displaying of the command is performed after the displaying of the command guide information is performed.

9. The method of claim 1, wherein displaying the chatbot response message further comprises displaying command guide information for the chatbot at a location corresponding to the chatbot response message in the message display window of the chat room.

10. The method of claim 9, wherein the command guide information displayed in the message display window comprises command options for commands other than the command corresponding to the input information.

11. The method of claim 1, wherein:
acquiring the input for specifying the chatbot comprises:
displaying list information about participating chatbots that are participating in the chat room; and
acquiring an input for specifying the chatbot through the list information for specifying a chatbot, and
wherein a manner in which the list information is displayed is determined based on at least one of a chat history of the chat room and a command usage history of the user.

12. The method of claim 11, wherein:
the list information comprises command guide information for one of the participating chatbots, and
the command guide information for the chatbot is displayed as a replacement for command guide information for one of the participating chatbots.

13. The method of claim 1, wherein in acquiring the input for specifying the chatbot, the input for specifying the chatbot comprises an input for utterance information of the chatbot in the chat room.

14. The method of claim 13, wherein the input for the utterance information of the chatbot comprises at least one of an input for replying to a spoken message from the chatbot and an input for speaker information of the chatbot.

15. The method of claim 1, wherein the command guide information comprises an interface for requesting a chatbot response message corresponding to a command and an interface related to settings of the chatbot.

16. The method of claim 15, wherein the interface related to the settings of the chatbot comprises at least one of an interface for resetting configuration settings of the chatbot and an interface for allowing a proactive message that is not a response to a command message.

17. A user terminal displaying command guide information for a chatbot, comprising:
a memory storing instructions, and
a processor configured to execute the instructions to:
acquire an input for specifying a chatbot through a chat room, the chatbot providing a chatbot response message corresponding to the command through the chat room;
display command guide information for the chatbot in the chat room;
acquire input information for a command based on the command guide information;
display a command message comprising the command corresponding to the input information in the chat room; and
display a chatbot response message corresponding to the command message in the chat room.

18. A method for providing command guide information for a chatbot by a server, comprising:
receiving information for specifying a chatbot from a user terminal, the chatbot providing a chatbot response message corresponding to a command through a chat room;
providing the user terminal with command guide information for the chatbot;
receiving, from the user terminal, a command message comprising a command input based on the command guide information; and
providing the user terminal with a chatbot response message corresponding to the command message.
